(19) United States
(12) Patent Application Publication
(10) Pub. No.: US 2023/0239550 A1
(43) Pub. Date: Jul. 27, 2023

(54) RELAY SERVER AND DISTRIBUTION IMAGE GENERATION METHOD

(71) Applicant: Sony Interactive Entertainment Inc., Tokyo (JP)

(72) Inventor: Masahiro FUJIHARA, Tokyo (JP)

(73) Assignee: Sony Interactive Entertainment Inc., Tokyo (JP)

(21) Appl. No.: 17/918,992

(22) PCT Filed: May 7, 2020
(86) PCT No.: PCT/JP2020/018585

§ 371 Date: Oct. 14, 2022

(51) Int. Cl. H04N 21/854; H04N 21/2187; H04N 21/234

(52) U.S. Cl. CPC H04N 21/854; H04N 21/2187; H04N 21/23424

(57) ABSTRACT

A first acquisition section acquires a content image from an information processing apparatus. A second acquisition section acquires a camera image from the information processing apparatus. A synthesis processing section generates a distribution image by combining the content image with the camera image. A transmission processing section transmits the generated distribution image to an image sharing server.

### TECHNICAL FIELD

The present invention relates to a technology for generating a distribution image and a technology for transmitting the distribution image.

### BACKGROUND ART

Disclosed in PTL 1 is a system that distributes display images including images of a game played by a distributing user to viewing users through a sharing server. The display images include game images, comments transmitted from the viewing users, and camera images depicting the distributing user. An information processing apparatus of the distributing user encodes the display images and transmits the encoded display images to the sharing server. This enables the viewing users to view the same display images as the distributing user.

### CITATION LIST

### Patent Literature

[PTL 1] PCT Patent Publication No. WO 2014/068806

### SUMMARY

### Technical Problem

Advanced arithmetic processing is required by recent gaming programs. Hence, the rate of use of a CPU (Central Processing Unit) by the gaming programs is often high. Since the CPU is additionally used for distribution processing during game image distribution, it is preferable that processing load other than the load imposed by arithmetic processing for program execution and distribution processing be minimized.

As such, an object of the present invention is to provide a technology for increasing the usefulness of an image sharing system that distributes content images of, for example, a game to viewing users.

### Solution to Problem

In order to solve the above problem, according to an aspect of the present invention, there is provided a relay server that is connected to an information processing apparatus operated by a user and to an image sharing server. The relay server includes a first acquisition section, a second acquisition section, a synthesis processing section, and a transmission processing section. The first acquisition section acquires a content image from the information processing apparatus. The second acquisition section acquires a camera image from the information processing apparatus. The synthesis processing section generates a distribution image by combining the content image with the camera image. The transmission processing section transmits the generated distribution image to the image sharing server.

According to another aspect of the present invention, there is provided a distribution image generation method adopted by a relay server that is connected to an information processing apparatus operated by a user and to an image sharing server. The distribution image generation method includes the steps of acquiring a content image from the information processing apparatus, acquiring a camera image from the information processing apparatus, and generating a distribution image by combining the content image with the camera image.

Any combinations of the abovementioned component elements and any conversions of expressions of the present invention between, for example, methods, apparatuses, systems, recording media, and computer programs are also effective as the aspects of the present invention.

### Advantageous Effects of Invention

The present invention provides a technology for increasing the usefulness of an image sharing system that distributes content images to viewing users.

### BRIEF DESCRIPTION OF DRAWINGS

FIG. 1 is a diagram illustrating an image sharing system according to an embodiment.

FIG. 2 is a diagram illustrating a hardware configuration of an information processing apparatus.

FIG. 3 is a diagram illustrating functional blocks of the information processing apparatus.

FIG. 4 is a diagram illustrating an example of a game screen.

FIG. 5 is a diagram illustrating an example of an input screen that lists sharing process options.

FIG. 6 is a diagram illustrating an example of a setting screen.

FIG. 7 is a diagram illustrating an example of another setting screen.

FIG. 8 is a diagram illustrating functional blocks of a relay server.

FIG. 9 is a diagram illustrating an example of a synthesized distribution image.

### DESCRIPTION OF EMBODIMENT

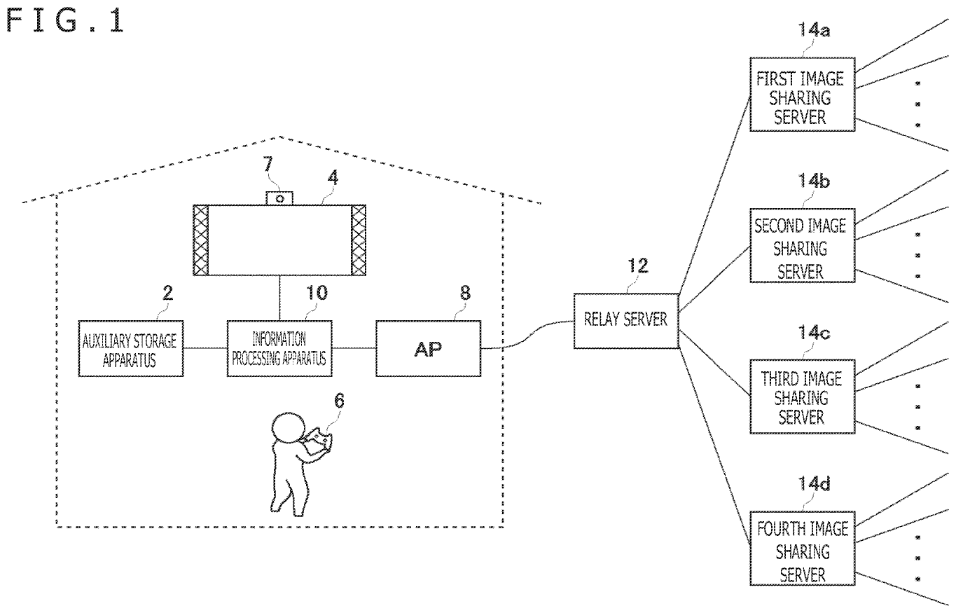

FIG. 1 illustrates an image sharing system 1 according to an embodiment of the present invention. The image sharing system 1 according to the embodiment establishes an environment where a user acting as a distributor (hereinafter also referred to as the “distributing user”) live-streams game images and game sounds (game images and sounds) during a play to allow viewing users to view and listen to the game images and sounds. In the embodiment, the distributing user streams the game images and sounds of a game the distributing user is currently playing. However, the content to be streamed is not limited to games. Other types of video content may alternatively be streamed.

The image sharing system 1 includes an information processing apparatus 10 operated by the distributing user, a relay server 12, and a first image sharing server 14a, a second image sharing server 14b, a third image sharing server 14c, and a fourth image sharing server 14d (hereinafter referred to as the “image sharing servers 14” unless specifically distinguished from each other) that are configured to supply the game images and sounds to the viewing users. The relay server 12 is connected to the information processing apparatus 10 and the image sharing servers 14 through a network such as the Internet. It is preferable that the image sharing system 1 include a plurality of image sharing servers 14. However, the image sharing system 1 may include only one image sharing server 14. The plurality of image sharing servers 14 may respectively be operated by a plurality of different business entities. However, the image sharing servers 14 may alternatively be operated by only one business entity that provides different types of services.

Configurations of peripherals of the information processing apparatus 10 will now be described. An access point (hereinafter referred to as the “AP”) 8 functions as a wireless access point and as a router. The information processing apparatus 10 is wirelessly or wiredly connected to the AP 8, and communicatively connected to the relay server 12 in the network. The information processing apparatus 10 can be directly connected to the image sharing servers 14 to transmit a distribution image to the image sharing servers 14. However, when the information processing apparatus 10 transmits the distribution image to the image sharing servers 14 through the relay server 12, the processing load imposed on video distribution can be reduced.

An input apparatus 6 operated by a user is wirelessly or wiredly connected to the information processing apparatus 10, and configured to output information regarding an operation performed by the user to the information processing apparatus 10. Upon receiving the operation information from the input apparatus 6, the information processing apparatus 10 causes the received operation information to be reflected in the processing of system software and application software, and causes an output apparatus 4 to output the result of processing. In the embodiment, the information processing apparatus 10 is a game apparatus for executing a game program. Hence, the input apparatus 6 may be a game controller. The input apparatus 6 includes a plurality of input sections such as operation pushbuttons, an analog stick capable of inputting an analog amount, and a rotating button.

An auxiliary storage apparatus 2 is a storage such as an HDD (hard disk drive) or an SSD (solid state drive), and may be a built-in storage apparatus or an external storage apparatus connected to the information processing apparatus 10 through, for example, a USB (Universal Serial Bus). The output apparatus 4 may be a television set including a display configured to output images and a speaker configured to output sounds. Alternatively, the output apparatus 4 may be a head-mounted display. A camera 7 captures, at predetermined intervals, an image of a space where the user is present, and outputs the captured image to the information processing apparatus 10. The camera 7 is a stereo camera, so that the information processing apparatus 10 can calculate depth information from an image captured by two camera lenses.

In the image sharing system 1, game images and game sounds (game images and sounds) are distributed to the viewing users. The following description particularly deals with handling of game images in distribution. In the image sharing system 1, the information processing apparatus 10 transmits, to the relay server 12, a game image of a game currently played by the user, the relay server 12 generates a distribution image and transmits the distribution image to the image sharing servers 14, and the image sharing servers 14 broadcast the distribution image to the viewing users. As described above, the image sharing system 1 operates as a content image distribution system.

The relay server 12 provides the user with a relay service for relaying streams, and the image sharing servers 14 provide the user with an image sharing service for distributing the streams. A network account is set in both the relay server 12 and the image sharing servers 14 in order to identify the user. Upon being notified of the network account for the image sharing service by the user, the relay server 12 links the network account for the relay service to the network account for the image sharing service, and exercises management accordingly.

Before the start of distribution, the user signs into the relay server 12 by using the network account for the relay service. The relay server 12 receives, from the user, designation of one or more image sharing services for use in distribution, and prompts the user to sign into the image sharing servers 14 with use of the network accounts for the designated image sharing services.

After the start of distribution, the relay server 12 receives, from the information processing apparatus 10, a game image and a user image captured by the camera 7 (hereinafter referred to as the “camera image”) through separate streams, and generates distribution images by combining the game image with the camera image. Since synthesis processing for distribution image generation is performed by the relay server 12, the information processing apparatus 10 does not need to perform synthesis processing. The relay server 12 transmits the generated distribution images to the image sharing servers 14 that provide the image sharing services designated by the user. The image sharing servers 14 in the embodiment are video distribution servers, and configured to receive the distribution images from the relay server 12 and stream the distribution images to terminal equipment of the viewing users.

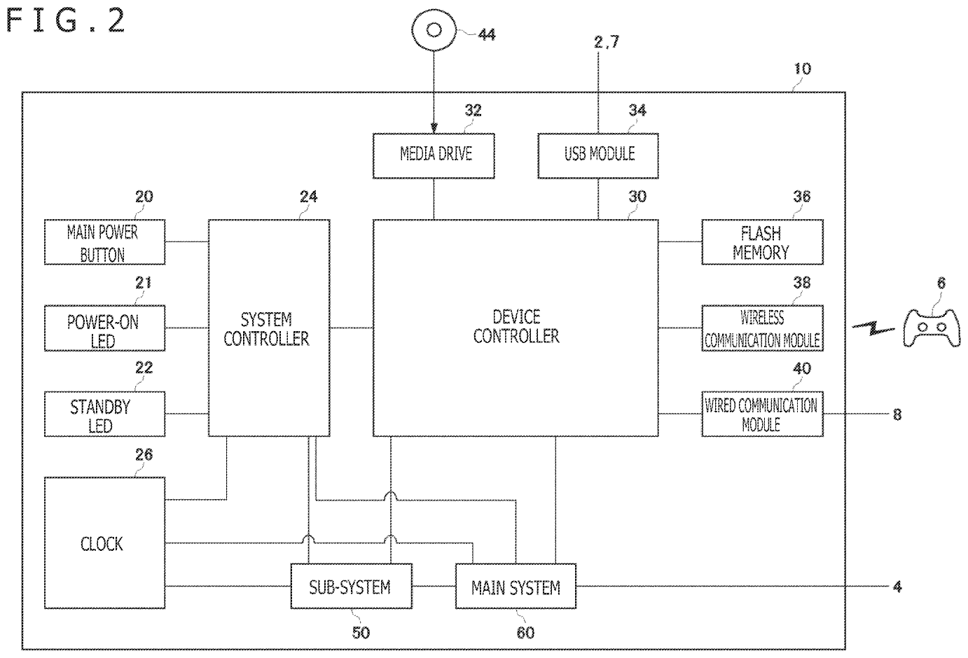

FIG. 2 illustrates a hardware configuration of the information processing apparatus 10. The information processing apparatus 10 includes a main power button 20, a power-ON LED (Light Emitting Diode) 21, a standby LED 22, a system controller 24, a clock 26, a device controller 30, a media drive 32, a USB module 34, a flash memory 36, a wireless communication module 38, a wired communication module 40, a sub-system 50, and a main system 60.

The main system 60 includes, for example, a main CPU, a memory acting as a main storage, a memory controller, and a GPU (Graphics Processing Unit). The GPU is mainly used for arithmetic processing of a game program. These functions may be configured as a system on a chip and formed on a single chip. The main CPU has a function of executing a game program recorded in the auxiliary storage apparatus 2 or a ROM (Read Only Memory) medium 44.

The sub-system 50 includes, for example, a sub-CPU, a memory acting as a main storage, and a memory controller, but does not include a GPU nor does it have a function of executing a game program. The sub-CPU has a smaller number of circuit gates than the main CPU, and is lower in power consumption than the main CPU. The sub-CPU operates even while the main CPU is in standby, and has limited processing functions in order to reduce the power consumption.

The main power button 20, which is an input section for receiving user's operation input, is disposed on the front surface of a housing of the information processing apparatus 10 and operated to turn on or off the power supply to the main system 60 of the information processing apparatus 10. The power-ON LED 21 illuminates when the main power button 20 is turned on. The standby LED 22 illuminates when the main power button 20 is turned off.

The system controller 24 detects that the main power button 20 is depressed by the user. When the main power button 20 is depressed while the main power supply is off, the system controller 24 acquires such a depression operation as an “ON instruction.” On the other hand, when the main power button 20 is depressed while the main power supply is on, the system controller 24 acquires such a depression operation as an “OFF instruction.”

The clock 26, which is a real-time clock, generates current date and time information, and supplies the generated current date and time information to the system controller 24, the sub-system 50, and the main system 60. The device controller 30 is configured as an LSI (Large-Scale Integrated Circuit) that transfers information between devices like a southbridge. As depicted in FIG. 2, the device controller 30 is connected to such devices as the system controller 24, the media drive 32, the USB module 34, the flash memory 36, the wireless communication module 38, the wired communication module 40, the sub-system 50, and the main system 60. The device controller 30 absorbs the differences in the electrical properties and data transfer rate of the individual devices, and controls the timing of data transfer.

The media drive 32 is a drive apparatus that, when the ROM medium 44, which stores application software and license information regarding, for example, a game, is inserted into the media drive 32, drives the ROM medium 44 and reads, for example, programs and data from the ROM medium 44. The ROM medium 44 may be an optical disc, a magneto-optical disc, a Blu-ray Disc, or other read-only recording media.

The USB module 34 is a module that is to be connected to external equipment with a USB cable. The USB module 34 may be connected to the auxiliary storage apparatus 2 and the camera 7 with a USB cable. The flash memory 36 is an auxiliary storage apparatus configured as an internal storage. The wireless communication module 38 wirelessly communicates, for example, with the input apparatus 6 in accordance with a communication protocol such as the Bluetooth (registered trademark) protocol or the IEEE (Institute of Electrical and Electronics Engineers) 802.11 protocol. The wired communication module 40 wiredly communicates with the external equipment and connects to an external network through the AP 8.

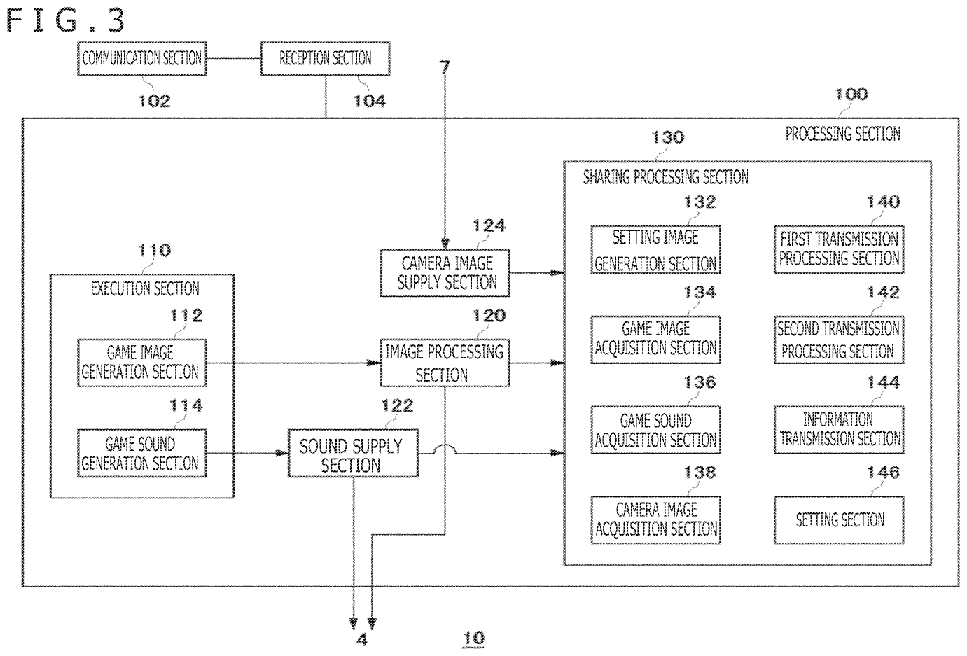

FIG. 3 illustrates functional blocks of the information processing apparatus 10, which operates as a streaming data transmission apparatus. The information processing apparatus 10 includes a processing section 100, a communication section 102, and a reception section 104. The processing section 100 includes an execution section 110, an image processing section 120, a sound supply section 122, a camera image supply section 124, and a sharing processing section 130. The execution section 110 includes a game image generation section 112 and a game sound generation section 114. The sharing processing section 130 includes a setting image generation section 132, a game image acquisition section 134, a game sound acquisition section 136, a camera image acquisition section 138, a first transmission processing section 140, a second transmission processing section 142, an information transmission section 144, and a setting section 146.

Described with reference to FIG. 3, individual elements depicted as the functional blocks for performing various processes may be formed by hardware, such as a circuit block, a memory, or other LSIs, and implemented by software, such as system software or a game program loaded into a memory. Hence, it will be understood by persons skilled in the art that the functional blocks may variously be implemented by hardware only, by software only, or by a combination of hardware and software. The method of implementing the functional blocks is not specifically limited to any kind.

The communication section 102 receives the operation information inputted by the user who operates the input section of the input apparatus 6, and transmits distribution data generated by the processing section 100 to the relay server 12. The processing section 100 generates, as the distribution data, stream data obtained by combining a game image with a game sound and stream data including a camera image. The communication section 102 then transmits the distribution data to the relay server 12 as a separate stream. The functional block depicted as the communication section 102 is expressed as a configuration having the function of the wireless communication module 38 and the function of the wired communication module 40 that are depicted in FIG. 2.

The reception section 104 is disposed between the communication section 102 and the processing section 100, and configured to transmit data or information between the communication section 102 and the processing section 100. Upon receiving the operation information regarding the input apparatus 6 through the communication section 102, the reception section 104 supplies the received operation information to a predetermined functional block in the processing section 100.

The execution section 110 executes a game program (hereinafter simply referred to as the “game” in some cases). In this instance, the functional blocks of the execution section 110 are implemented, for example, by software such as system software or game software or by hardware such as a GPU. Upon receiving the result of execution of the game program, the game image generation section 112 generates image data of a game, and the game sound generation section 114 generates sound data of the game. It should be noted that the game is an example of an application. The execution section 110 may execute an application other than the game.

While the game is being played by the user, the execution section 110 executes the game program, and performs arithmetic processing for moving a game character in a virtual space in reference to the operation information inputted to the input apparatus 6 by the user. The game image generation section 112 includes a GPU for performing, for example, a rendering process, and upon receiving the result of arithmetic processing in the virtual space, generates game image data as viewed from a viewpoint position (virtual camera) in the virtual space. The game sound generation section 114 generates game sound data in the virtual space.

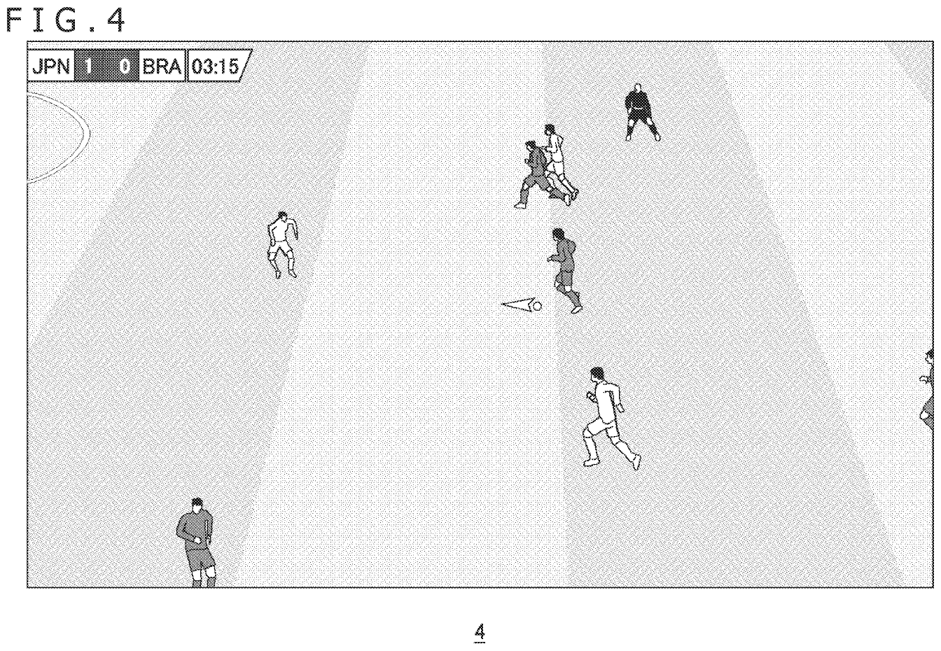

FIG. 4 illustrates an example of a game screen that is displayed on the output apparatus 4 of the user. While the game is being played by the user, the game image generation section 112 generates a game image and supplies the generated game image to the image processing section 120, and the game sound generation section 114 generates a game sound and supplies the generated game sound to the sound supply section 122. The image processing section 120 supplies the game image to the output apparatus 4, and the sound supply section 122 supplies the game sound to the output apparatus 4. The output apparatus 4 outputs the game image and the game sound, and the user plays the game while viewing and listening to the game image and sound outputted from the output apparatus 4.

A sharing process performed in the embodiment will now be described.

The sharing processing section 130 performs a process of allowing image and sound data of a game currently played by the user to be shared by other viewing users through the relay server 12 and the image sharing servers 14. The sharing process for sharing the game image and sound data starts when the user operates a specific input button (SHARE button) disposed on the input apparatus 6, and the setting image generation section 132 generates an input image indicative of options for sharing the image and sound data.

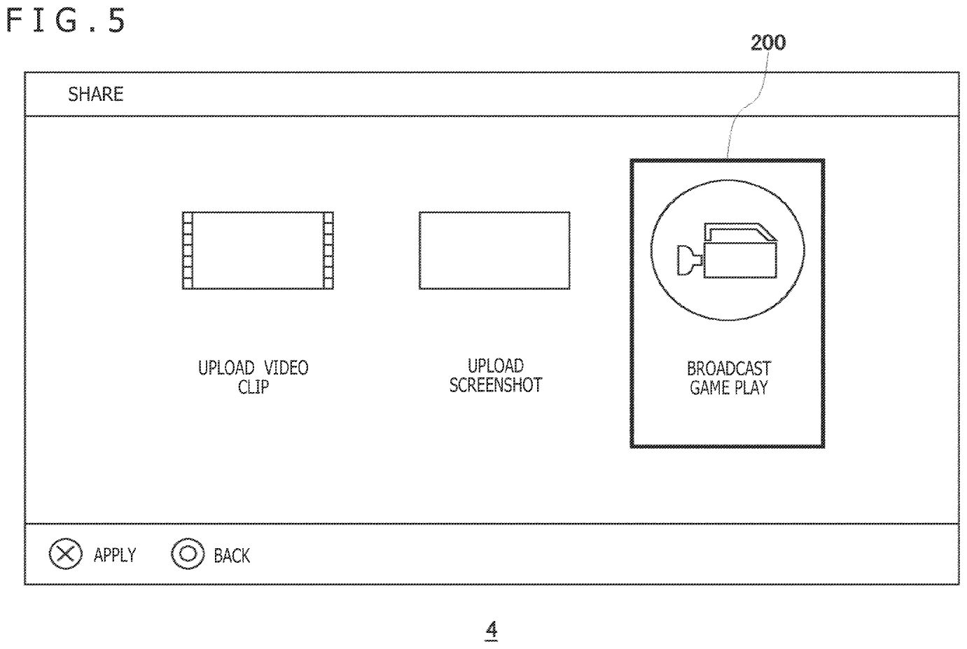

FIG. 5 illustrates an example of the input screen that lists sharing process options. The setting image generation section 132 generates the input image indicative of the sharing process options, and supplies the generated input image to the image processing section 120. The image processing section 120 causes the output apparatus 4 to display the input image indicative of the sharing process options.

The input screen displays three options for sharing the image and sound data. “Upload video clip” is a GUI (Graphical User Interface) element that issues instructions for uploading images recorded in the auxiliary storage apparatus 2 to the image sharing servers 14. “Upload screenshot” is a GUI element that issues instructions for uploading screenshot images to the image sharing servers 14. “Broadcast game play” is a GUI element that issues instructions for doing a live broadcast of the game image and sound data through the image sharing servers 14. When the user operates the input apparatus 6 to move a selection frame 200 as needed and select a specific GUI element and then depresses the Apply button, the execution of the selected sharing process starts.

In the embodiment, the GUI element for “Broadcast game play” is selected. After this GUI element is selected, the setting image generation section 132 causes the output apparatus 4 to display a setting screen that prompts the user to select setting information for broadcast distribution.

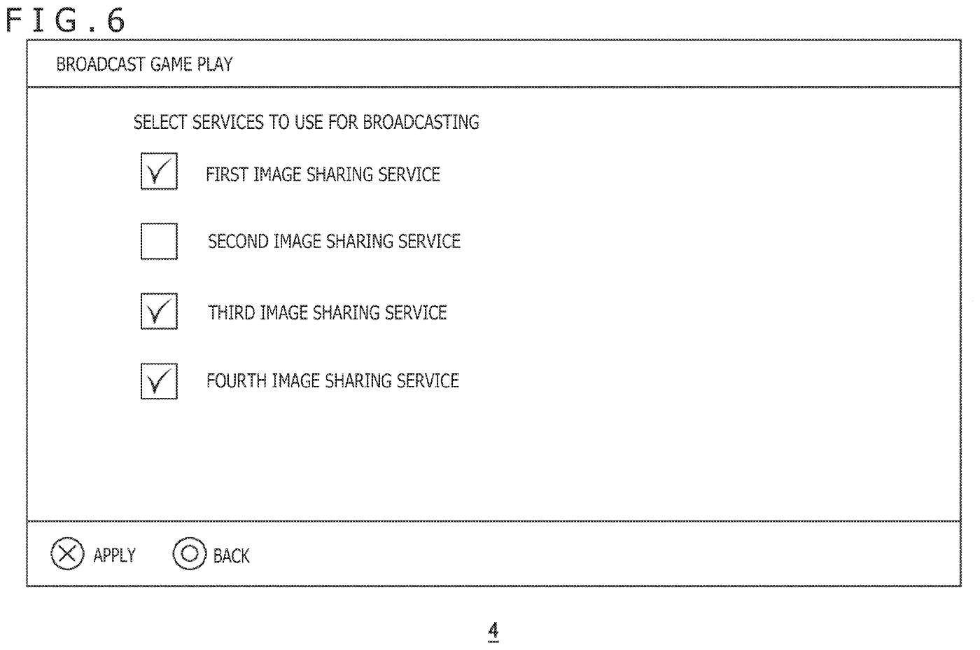

FIG. 6 illustrates an example of the setting screen that is displayed when “Broadcast a game play” is selected. From a plurality of image sharing services displayed on this setting screen, the user selects one or more image sharing services to use. In the example depicted in FIG. 6, a first image sharing service, a second image sharing service, a third image sharing service, and a fourth image sharing service are presented as selectable image sharing services. Here, the first image sharing service is provided by the first image sharing server 14a; the second image sharing service is provided by the second image sharing server 14b; the third image sharing service is provided by the third image sharing server 14c; and the fourth image sharing service is provided by the fourth image sharing server 14d. In the image sharing system 1 in the embodiment, the user is able to select a plurality of image sharing services.

In an image sharing system that distributes game images with the information processing apparatus 10 directly connected to the image sharing servers 14 unlike the image sharing system in the embodiment, the information processing apparatus 10 needs to transmit a game image to each of the plurality of image sharing servers 14 in order to use a plurality of image sharing services. For example, in a case where three image sharing services are used for game image distribution, the information processing apparatus 10 needs to transmit a game image to each of the three image sharing servers 14. This results in an increase in the CPU load for distribution processing.

Meanwhile, the image sharing system 1 in the embodiment is configured such that the relay server 12 plays a role of transmitting a game image to the plurality of image sharing servers 14. Hence, it is sufficient if the information processing apparatus 10 transmits the game image to only the relay server 12. This results in a relative decrease in the CPU load for distribution processing. In the example depicted in FIG. 6, the user selects the checkboxes for three image sharing services to designate the distribution of live video through the first image sharing server 14a, the third image sharing server 14c, and the fourth image sharing server 14d. When the user operates the Apply button on the input apparatus 6, the setting image generation section 132 causes the output apparatus 4 to display another setting screen.

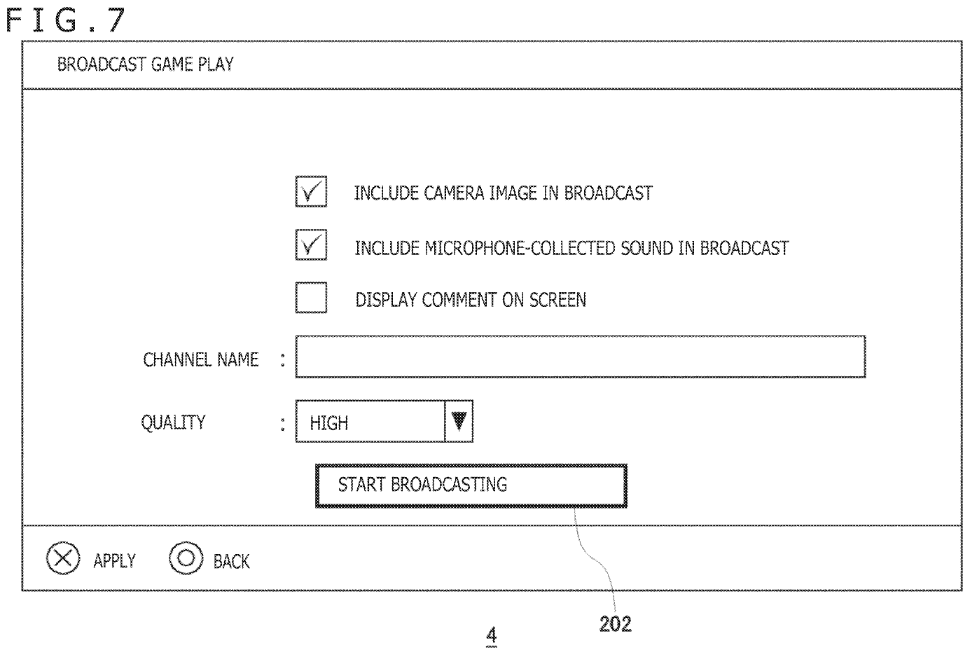

FIG. 7 illustrates an example of another setting screen that is displayed when “Broadcast game play” is selected. This setting screen contains the following items for defining the mode of broadcast distribution.

(a) Item for Choosing Whether or not a Distribution Image is to Include a Camera Image

As regards item (a), the checkbox for “Include camera image in broadcast” may be selected by default. If the user does not want to distribute a camera image, the user deselects the checkbox. In a case where the checkbox for “Include camera image in broadcast” is selected, another option for setting the display position of a camera image may be presented to allow the user to specify the display position of the camera image.

(b) Item for Choosing Whether or not to Distribute a Microphone-Collected Sound

As regards item (b), the checkbox for “Include microphone-collected sound in broadcast” may be selected by default. If the user does not want to distribute a microphone-collected sound, the user deselects the checkbox.

(c) Item for Choosing Whether or not to Display a Viewing User's Comment on the Display Screen

As regards item (c), the checkbox for “Display comment on screen” may be selected by default. If the user does not want to display a comment, the user deselects the checkbox.

(d) Item for Selecting a Distribution Image Quality

As regards item (d), the user is allowed to select a resolution that is equal to or lower than the resolution of a game image displayed on the output apparatus 4. As the resolution of a distribution image, a resolution lower than the resolution of the game image displayed on the output apparatus 4 may be selected by default.

As regards game image broadcasting, the setting section 146 sets the user's selections regarding items (a) to (d). More specifically, when the user places a frame 202 over “Start broadcasting” and depresses the Apply button on the input apparatus 6, the setting section 146 not only registers the user's selections regarding items (a) to (d) in the auxiliary storage apparatus 2 as the setting information for broadcasting, but also reports the setting information to the image processing section 120, the sound supply section 122, and the camera image supply section 124.

A distribution process performed in a case where “Include camera image in broadcast” is selected as for item (a) will now be described. Before the start of the distribution process, the information transmission section 144 transmits, to the relay server 12, information for identifying the image sharing services to be used. In the present example, the information indicating the use of the first image sharing service, the third image sharing service, and the fourth image sharing service is transmitted from the information transmission section 144 to the relay server 12.

After the start of the distribution process, the image processing section 120 outputs the game image generated by the game image generation section 112 not only to the output apparatus 4 but also to the sharing processing section 130. Further, the sound supply section 122 outputs the game sound generated by the game sound generation section 114 not only to the output apparatus 4 but also to the sharing processing section 130. In a case where “Include microphone-collected sound in broadcast” is selected as for item (b), the sound supply section 122 combines the game sound with a sound signal (microphone-collected sound) inputted to a microphone (not depicted), and outputs the resulting combined sound signal to the sharing processing section 130. The camera image supply section 124 acquires a camera image from the camera 7, and supplies the acquired camera image to the sharing processing section 130. In this instance, the camera image supply section 124 calculates depth information from the image captured by the stereo camera, and supplies the depth information as well as the camera image to the sharing processing section 130.

In the sharing processing section 130, the game image acquisition section 134 acquires the game image supplied from the image processing section 120, and the game sound acquisition section 136 acquires the game sound supplied from the sound supply section 122. Time information (timestamp) is added to both the game image and the game sound. The first transmission processing section 140 adjusts the qualities of the acquired game image and game sound as needed, encodes the resulting game image and game sounds into a single stream (hereinafter also referred to as the “first stream”), and transmits the resulting stream to the relay server 12.

The camera image acquisition section 138 acquires a camera image supplied from the camera image supply section 124. Time information (timestamp) is also added to the camera image. The second transmission processing section 142 encodes the acquired camera image into a single stream (hereinafter also referred to as the “second stream”), and transmits the resulting stream to the relay server 12.

As described above, the sharing processing section 130 according to the embodiment transmits the game image and the camera image to the relay server 12 as separate streams without combining the game image and the camera image. This eliminates the necessity of causing the information processing apparatus 10 to perform a process of combining the game image and the camera image. Particularly in a case where the camera image to be included in the game image to be distributed is to be processed, causing the relay server 12 to perform required image processing reduces the processing load on the information processing apparatus 10.

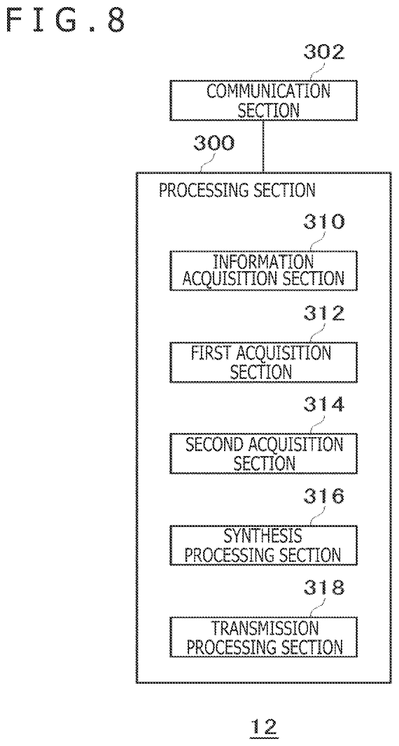

FIG. 8 is a diagram illustrating functional blocks of the relay server which relays a distribution image between the information processing apparatus and the image sharing servers. The relay server 12 includes a processing section 300 and a communication section 302. The processing section 300 includes an information acquisition section 310, a first acquisition section 312, a second acquisition section 314, a synthesis processing section 316, and a transmission processing section 318. The processing section 300 has a function of generating a distribution image by combining the game image with the camera image, and transmitting the distribution image and the game sound to the image sharing servers 14 as a single stream. The communication section 302 receives the first stream, which includes the game image, and the second stream, which includes the camera image, from the information processing apparatus 10, and transmits the distribution image generated by the processing section 300 to the image sharing servers 14.

Described with reference to FIG. 8, individual elements depicted as the functional blocks for performing various processes may be formed by hardware, such as a circuit block, a memory, or other LSIs, and implemented by software, such as system software or a game program loaded into a memory. Hence, it will be understood by persons skilled in the art that the functional blocks may variously be implemented by hardware only, by software only, or by a combination of hardware and software. The method of implementing the functional blocks is not specifically limited to any kind.

Before the start of distribution by the information processing apparatus 10, the information acquisition section 310 acquires, from the information processing apparatus 10, information for identifying the image sharing services to be used by the user, that is, information identifying the image sharing servers 14 that are to distribute distribution images. Upon receiving the information for identifying the first image sharing service, the third image sharing service, and the fourth image sharing service as depicted in FIG. 6, the information acquisition section 310 identifies that the first image sharing server 14a, the third image sharing server 14c, and the fourth image sharing server 14d act as distribution sources of the distribution images, and then notifies the transmission processing section 318 of the result of such identification.

After the start of distribution by the information processing apparatus 10, the first acquisition section 312 acquires the first stream, which includes the game image, from the information processing apparatus 10, and the second acquisition section 314 acquires the second stream, which includes the camera image, from the information processing apparatus 10. It should be noted that, as mentioned earlier, the first stream includes the game sound as well, and additionally includes a microphone-collected sound in a case where the distribution of the microphone-collected sound is permitted by the user. Generated time information (timestamp) is added to both the first stream and the second stream.

By using the timestamp added to each of the first and second streams, the synthesis processing section 316 generates a distribution image obtained by combining the game image and the camera image that are matched in terms of generated time.

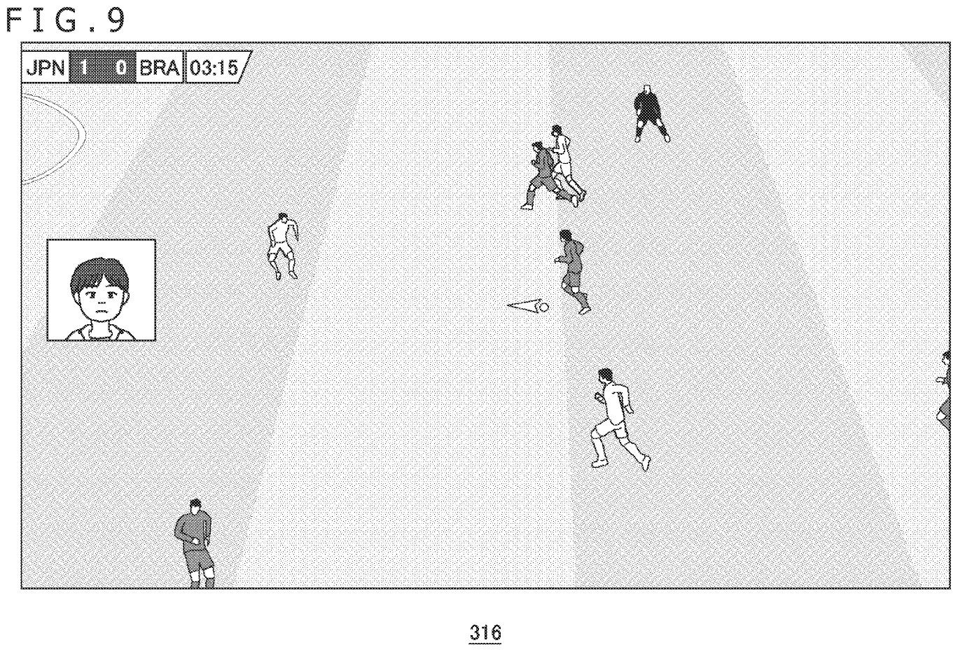

FIG. 9 illustrates an example of a distribution image synthesized by the synthesis processing section 316. The synthesis processing section 316 combines the game image and the camera image that agree in time indicated by the timestamp. In the example depicted in FIG. 9, the camera image is superimposed over the game image. However, an alternative synthesis method may be adopted.

It should be noted that the second stream acquired by the second acquisition section 314 includes the camera image as well as the depth information regarding the camera image. The camera image includes an image of the distributing user and an image of the distributing user's background. However, the synthesis processing section 316 may cut out the distributing user's image included in the camera image from the background image by using the depth information and then combine the cut-out distributing user's image with the game image. Processing the camera image in the above manner prevents the image of the distributing user's background included in the camera image from being superimposed over the game image.

In reference to the information acquired by the information acquisition section 310, the transmission processing section 318 transmits distribution images generated by the synthesis processing section 316 to the image sharing servers 14. In the present example, the transmission processing section 318 transmits the distribution images to the first image sharing server 14a, the third image sharing server 14c, and the fourth image sharing server 14d, and then the first image sharing server 14a, the third image sharing server 14c, and the fourth image sharing server 14d distribute the distribution images to the viewing users. As described above, since the image sharing system 1 includes the relay server 12, it is possible to reduce a distribution load on the information processing apparatus 10 and a load regarding camera image processing.

The present invention has been described above in terms of an embodiment. The foregoing embodiment is illustrative and not restrictive. Persons skilled in the art will understand that the combination of the component elements and processes of the embodiment may variously be modified, and that such modifications are also within the scope of the present invention. The embodiment has been described in relation to the distribution of game images. However, the technology provided by the present invention is also applicable to the distribution of content other than games.

### INDUSTRIAL APPLICABILITY

The present invention is applicable to a technology for distributing content images.

### REFERENCE SIGNS LIST

1: Image sharing system
10: Information processing apparatus
12: Relay server
14: Image sharing server
14a: First image sharing server
14b: Second image sharing server
14c: Third image sharing server
14d: Fourth image sharing server
100: Processing section
102: Communication section
104: Reception section
110: Execution section
112: Game image generation section
114: Game sound generation section
120: Image processing section
122: Sound supply section
124: Camera image supply section
130: Sharing processing section
132: Setting image generation section
134: Game image acquisition section
136: Game sound acquisition section
138: Camera image acquisition section
140: First transmission processing section
142: Second transmission processing section
144: Information transmission section
146: Setting section
300: Processing section
302: Communication section
310: Information acquisition section
312: First acquisition section
314: Second acquisition section
316: Synthesis processing section
318: Transmission processing section

1. A relay server connected to an information processing apparatus operated by a user and to an image sharing server, the relay server comprising:
a first acquisition section that acquires a content image from the information processing apparatus;
a second acquisition section that acquires a camera image from the information processing apparatus;
a synthesis processing section that generates a distribution image by combining the content image with the camera image; and
a transmission processing section that transmits the generated distribution image to the image sharing server.

2. The relay server according to claim 1, wherein
the second acquisition section acquires not only the camera image but also depth information regarding the camera image, and
the synthesis processing section cuts out a user's image included in the camera image, by using the depth information, and combines the cut-out user's image with the content image.

3. The relay server according to claim 1, further comprising:
an information acquisition section that acquires, from the information processing apparatus, information for identifying the image sharing server that is to distribute the distribution image,
wherein the transmission processing section transmits the distribution image in reference to the information acquired by the information acquisition section.

4. A distribution image generation method adopted by a relay server that is connected to an information processing apparatus operated by a user and to an image sharing server, the distribution image generation method comprising:
acquiring a content image from the information processing apparatus;
acquiring a camera image from the information processing apparatus; and
generating a distribution image by combining the content image with the camera image.

5. A non-transitory, computer readable storage medium containing a computer program, which when executed by a computer connected to an information processing apparatus operated by a user and to an image sharing server, causes the combination to perform a distribution image generation method by carrying out actions, comprising:
acquiring a content image from the information processing apparatus;
acquiring a camera image from the information processing apparatus;
generating a distribution image by combining the content image with the camera image; and
transmitting the generated distribution image to the [symbol]
